(19) United States
(12) Patent Application Publication
(10) Pub. No.: US 2004/0251650 A1
(43) Pub. Date: Dec. 16, 2004

(54) Skateboard wheels with lightweight removable press-fit hubs

(76) Inventors: Victor K. Katsuyama, Laguna Hills, CA (US); Kenny A. Gallagher, Corona, CA (US)

Correspondence Address: LEONARD TACHNER, A PROFESSIONAL LAW, CORPORATION, 17961 SKY PARK CIRCLE, SUITE 38-E, IRVINE, CA, 92614

(21) Appl. No.: 10/458,018

(22) Filed: Jun. 11, 2003

(51) Int. Cl. B62M 1/00

(52) U.S. Cl. 280/87.042

(57) ABSTRACT

A skateboard wheel having uniquely configured removable hubs. The hubs of the present invention engage the wheel by being press-fit into the opposed sides of the wheel skin without any fastening elements. The wheel skin, preferably made of urethane, is configured to receive the hubs in such press-fit engagement so that the hubs firmly and securely engage the wheel skin in an overall lightweight and aesthetically pleasing configuration which appeals to skateboarders for both their performance and convenience.

### BACKGROUND OF THE INVENTION

1. Field of the Invention

The present invention relates generally to the field of skateboard wheels and more specifically to a skateboard wheel having hubs which are secured to the wheel's urethane skin exterior by press-fit engagement, thereby obviating heavy fasteners such as bolts and the like.

2. Background Art

In recent years it has become fashionable for skateboarders to use urethane skin wheels with a variety of exotic removable hubs. For best performance it is preferable for skateboard wheels to be lightweight. Therefore, it is desirable to use wheel hubs which are also lightweight and thus do not add significantly to the overall weight of the wheel. While removable hubs provide the skateboarder with the opportunity to modify the appearance and even the performance of his or her wheels, the hardware (i.e., bolts, screw, etc.) typically used to secure the removable hubs to the wheels, add to their overall weight. Thus it would be desirable to have a skateboard wheel with removable hubs which is extremely lightweight and which does not require the added weight of one or more fastening elements to secure the hubs to the wheel.

Prior art wheels having removable hubs are exemplified by U.S. Pat. No. 5,733,015 to Demarest et al. which relate primarily to wheels for skates. In FIG. 1 thereof, Demarest et al describe a skate wheel having a lateral wheel hub 50 and a medial wheel hub 52 which are engaged with each other “preferably by screws or bolts (not shown)” accommodated in the bolt holes 57 and bolt grooves 58.

In another roller skate example of wheels having removable hubs, Lekovich in U.S. Pat. No. 5,564,790 discloses a pair of hubs 12 held together by a plurality of threaded fasteners 60 and threaded bushings 62.

Thus there appears to still be a need for wheels for skateboards in which while the hubs may be both lightweight and removable, their design in conjunction with the remaining wheel structures obviates any need for heavy fastening elements. Such elements both add unnecessary weight and make it inconvenient to remove and replace the hubs in the field where tools to remove fasteners may be difficult to acquire.

### SUMMARY OF THE INVENTION

The present invention satisfies the aforementioned need by providing a skateboard wheel having uniquely configured removable hubs. The hubs of the present invention engage the wheel by being press-fit into the opposed sides of the wheel skin without any fastening elements. The wheel skin, preferably made of urethane, is configured to receive the hubs in such press-fit engagement so that the hubs firmly and securely engage the wheel skin in an overall lightweight and aesthetically pleasing configuration which appeals to skateboarders for both their performance and convenience.

In an illustrative embodiment of the invention disclosed herein, the urethane wheel skin is designed with an internal annular shoulder which the opposing hubs bear axially upon installation into the wheel skin. The remaining internal surface of the wheel skin is carefully shaped to be only slightly greater in diameter than the hubs so that the latter firmly engage the former in press-fit relation.

It will be seen hereinafter that the hubs are preferably made of a lightweight metal such as aluminum or an alloy thereof. It will also be seen that the hubs are preferably further reduced in their weight by a series of closely-spaced through-holes which extend along the outer radial periphery of the hubs in a manner which lends symmetry and aesthetic beauty to the wheel appearance.

### BRIEF DESCRIPTION OF THE DRAWINGS

The aforementioned advantages of the invention, as well as additional advantages thereof, will become more readily apparent from the following detailed description of at least one embodiment thereof when taken in conjunction with the accompanying drawings in which:

FIG. 1 is a three-dimensional view of a skateboard having wheels in accordance with the preferred embodiment of the invention;

FIG. 2 is an exploded view of the wheel area of the skateboard of FIG.1;

FIG. 3 is an exploded view of the wheel of FIG. 1;

FIG. 4 is an elevational view of the wheel skin of FIG. 3;

FIG. 5 is a cross-sectional view of the wheel skin;

FIG. 6 is an elevational view of the wheel hub of the wheel of FIG. 3;

FIG. 7 is a cross-sectional view taken along lines 7-7 of FIG. 6; and

FIG. 8 is a cross-sectional view of the wheel of FIG. 3 shown in its fully assembled configuration.

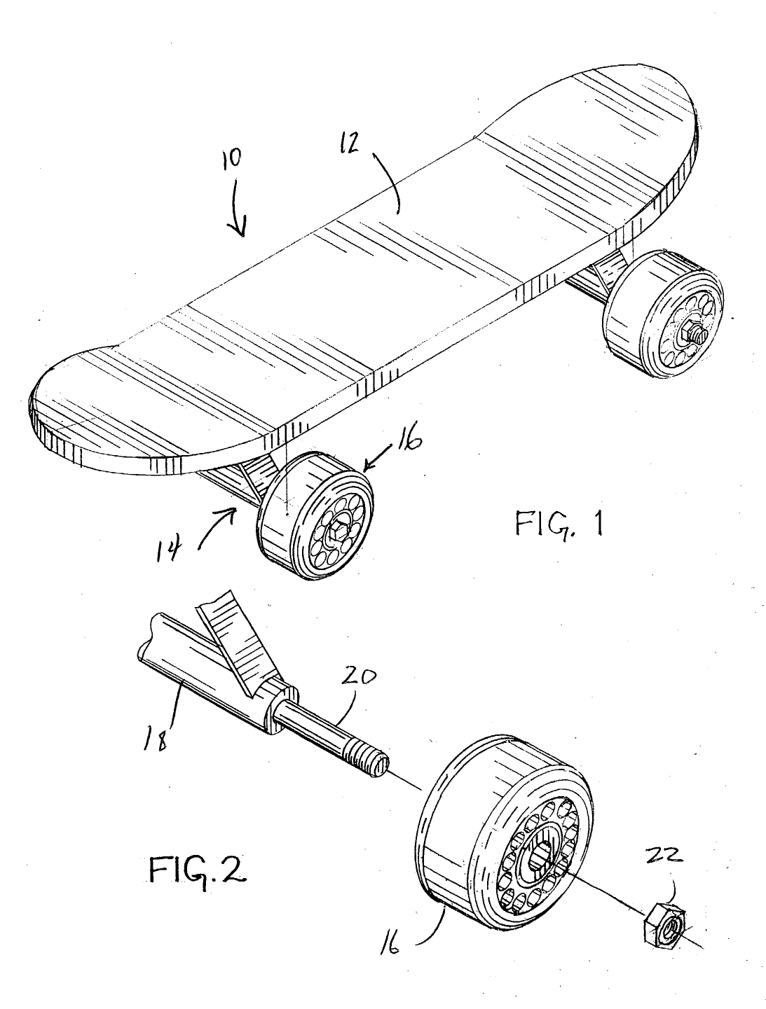

### DETAILED DESCRIPTION OF A PREFERRED EMBODIMENT

Referring to the accompanying drawings, it will be seen that a skateboard 10 having a deck 12 and trucks 14, has four wheels 16 each affixed to an axle 18 at a partially threaded shaft 20 by a threaded nut 22.

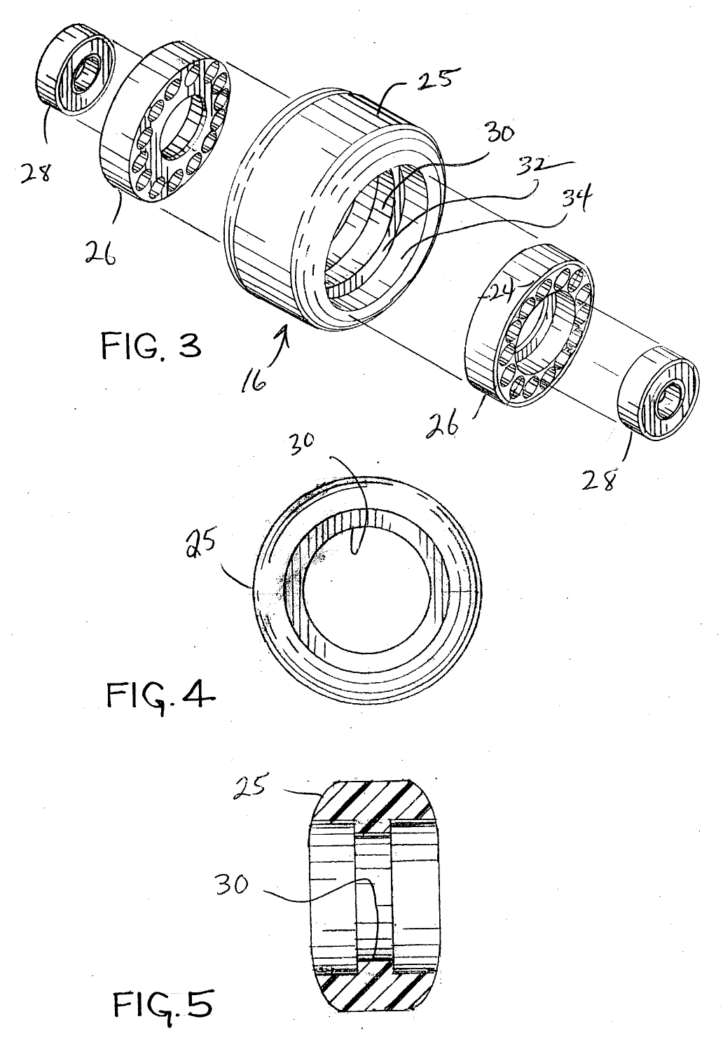

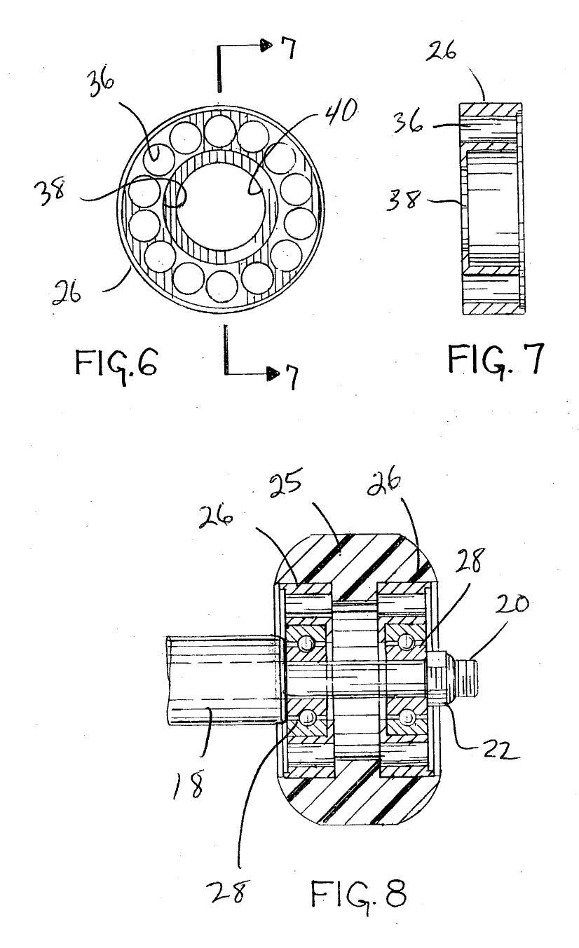

Each wheel 16 comprises a wheel skin 25 preferably made of a durable, lightweight material such as urethane or the like. In the preferred embodiment seen best in FIG. 3, each wheel 16 also comprises a pair of hubs 26 and a pair of ball bearing assemblies 28. The skin 25 is of a well-known exterior shape suitable for high performance skateboarding by skilled skateboarders. Internally however, each skin 25 is uniquely configured to provide an annular shoulder 30 symmetrically located at the mid-point of the width of the skin interior surface. Shoulder 30 is preferably of rectangular cross-section which provides opposed hub landings 32 for receiving respective hubs 26. The radial surface 34 receives the exterior radial surface 24 of the hub 26 in press-fit secure engagement.

Each removable hub 26, seen best in FIGS. 6 and 7, preferably has a plurality of weight-reducing apertures 36 placed symmetrically around the axial surface fo the hub. The center of each hub has a bearing recess 38 including a retaining flange 40 for receiving the ball bearing assembly 28. The difference in the lengths of the skin's inner diameter (at radial surface 34) and the hub's outer diameter (at radial surface 24) is preferably within 0.001″ so that each hub 26 is firmly secured within the skin 24.

A skateboarder may readily remove the hubs 26 from the skin 25 after removing the wheel 16 from the axle 18 by removing the nut 22. One will note that unlike prior art wheels, the hubs 26 are readily pushed out from the skin 25 without the need to remove any fasteners in the hubs.

Having thus described a preferred example of the invention, it will be understood that various modifications and additions are contemplated. By way of example, while hubs 26 are shown with circular apertures 36, it will be apparent that other shapes of weight-reducing apertures are possible because there are no fasteners required which would otherwise interfere with the shape, size or location of such apertures. Accordingly, the scope hereof is to be limited only by the appended claims and their equivalents.

We claim:

1. A skateboard wheel comprising:
a wheel skin having an exterior for engaging a ground surface and having an interior, said wheel skin interior having an annular shoulder;
at least one hub in said wheel skin interior bearing axially against said annular shoulder;
said hub being received in removable press-fit engagement with said wheel skin interior for being secured therein without fasteners.

2. The skateboard wheel recited in claim 1 wherein said at least one hub comprises an axial recess for receiving a ball bearing assembly.

3. The skateboard wheel recited in claim 1 wherein said at least one hub comprises a plurality of apertures located symmetrically about an axial surface of said hub.

4. The skateboard wheel recited in claim 1 wherein said at least one hub has a diameter which is about 0.001 inches less than the diameter of said wheel skin interior.

5. The skateboard wheel recited in claim 1 wherein said wheel skin is made of urethane and said hub is made of aluminum.

6. A skateboard comprising:
a skateboard deck supported by a pair of wheel truck assemblies, each such assembly having a pair of opposed wheels;
each said wheel having a wheel skin and a pair of opposed hubs on opposite axial surfaces of said wheel, each said hub being secured in said wheel skin by press-fit engagement with said wheel skin without fastening components.

7. The skateboard recited in claim 6 wherein each said hub comprises an axial recess for receiving a ball bearing assembly.

8. The skateboard recited in claim 6 wherein each said hub comprises a plurality of apertures located symmetrically about an axial surface of said hub.

9. The skateboard recited in claim 6 wherein said wheel skin is made of urethane and said hub is made of aluminum.
